(19) United States
(12) Patent Application Publication
(10) Pub. No.: US 2003/0205217 A1
(43) Pub. Date: Nov. 6, 2003

(54) Enhanced fuel injection via fuel identification delivery system

(76) Inventors: Michael Gene McIntyre, El Paso, TX (US); Tracy Dean McIntyre, El Paso, TX (US)

Correspondence Address: Michael Gene McIntyre, 6416 Isla Del Rey, El Paso, TX, 79912, US

(21) Appl. No.: 10/139,422

(22) Filed: May 6, 2002

(51) Int. Cl. F02M 51/00

(52) U.S. Cl. 123/486; 123/1 A

(57) ABSTRACT

Our invention is new to the art of fuel manufacturing, fuel identification, fuel handling, fuel transporting, fuel dispensing, and fuel injection because it will facilitate the delivery of the information about the fuel (the fuel's characteristics) along with the fuel. The fuel injection system will use this information (the data) to more accurately inject the fuel based on the fuel's characteristics into the engine, thus achieving better fuel economy, lower emissions, and more power output. As disclosed herein, after the data concerning the fuel's properties has been ascertained and preserved during transportation and delivery to the gas station it will be downloaded along with the fuel that is being pumped into the vehicle, the vehicle's fuel injection control module will then modify the amount of fuel that is going to be injected in relation to the fuel's properties to more accurately meter and inject the fuel being delivered.

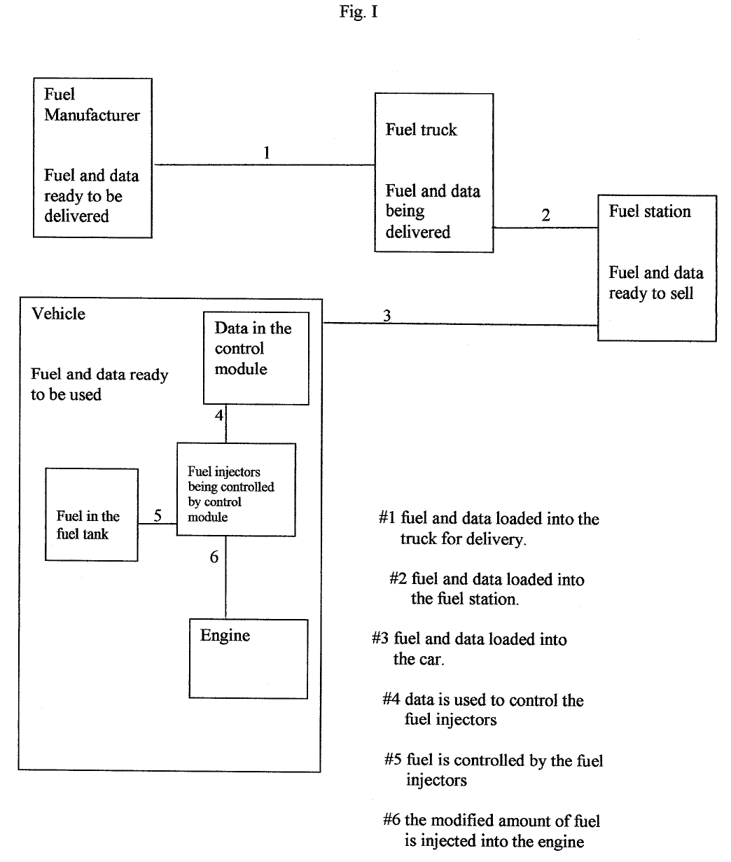

### THE INVENTION IS

A system and method to achieve better fuel economy, better power output and better emissions in electronically controlled fuel injected vehicles. This system will include a process to evaluate the fuel that is intended to be used in any electronically controlled fuel injected engine or, in layman's terms, the fuel at the pumps at the gas stations. The fuel will be evaluated prior to delivery to the fuel pumps at the gas station. Then the fuel and the data describing the fuel will be delivered to the pumps. During the fuels delivery to the pumps the data concerning the fuels properties will be down loaded into the fuel pump.

The pump will be modified to accept the data. The pump will be further modified as to enable the pump to determine the amount of fuel that was/is left over from the previous delivery. The pump will have soft ware that will make a computation as to the overall or combination of the fuels properties(previously delivered fuel and just delivered fuel). If necessary the pump will be able to circulate the just delivered fuel with the previously delivered fuel. This modification will also allow the pump to down load this data/information into any vehicle that has been modified to accept the data. This system and method will also include the modification of the fuel injection systems in current and future vehicles. The fuel injection systems in today's vehicles will be modified to accept the data and use the data to ascertain a more appropriate amount of fuel to be injected and therefore inject a more appropriate amount of fuel into the vehicle's engine. This modification will allow the control module on the vehicle to determine the amount of fuel that was/is left over from the previous or remaining fuel from the consumers last fuel stop. The control module will have software that will make a computation as to the fuel's overall or the combination of the fuels properties.

After this computation has been made, the control module will add to or subtract from the amount of time the fuel injector is open or how far the fuel injector is opened or in layman's terms, the amount of fuel that is to be injected by any means.

If the fuel has the properties that would warrant the need for more fuel i.e., the addition of anti-pollutants such as MTBE then the control module will add to the amount of time the injector is to open in contrast to the amount of time the injector would have been opened under normal circumstances. On the other hand if the fuel data reflects that the fuels properties warrant less fuel, then the control module will subtract form the amount of time the fuel injector is open compared to the amount of time the injector would have been opened under normal circumstances. In layman's terms if the fuel warrants less or more fuel then the control module will inject less or more fuel.

The properties to be evaluated would include but would not be limited to the specific gravity, octane, vapor pressure, sulfur content, oxidation stability, distillation properties, vapor-liquid ratio, phosphorus content, density, relative density, MTBE, ETBE, TAME, DIPE, tertiary-amly alcohol, C1 to C4 alcohol, gasoline-oxygenate blends, and all other methods of identifying fuel, etc.

This system will produce the most significant improvements in, fuel economy, power output drivability, as well as lowering emissions, etc. during the open loop function of current fuel injection technologies, but will also produce these same benefits during the closed loop operation.

The above-identified methods and systems for the identification of fuel can be utilized alone or in conjunction with other fuel system controlling techniques and dispensing techniques. Moreover, each of the specific steps involved in the processes, described herein are easily modified or tailored to meet the peculiar design and operational requirements of a particular engine and the anticipated operating environment in which the engine is used and any particular fuel dispensing machine and any particular equipment used in handling fuel.

The ability to modify the fuel map's quantity (the amount of fuel to be injected) in relation to the properties of the fuel that is in the fuel system will be an added benefit to any fuel injection system. The control module will decide based on the properties of the fuel the amount of additional fuel or how much fuel needs to be subtracted from the maps base volume. This addition or subtraction can be made before, during or after any additions or subtractions have been made on behalf of the other common sensors of today's fuel injection systems. Alternatively a multi map fuel injection system could be used. Wherein the control module is preprogrammed with multiple maps and a map is chosen based on the fuels properties. Once the control module has made its corrections/chosen its map the fuel injection system will perform in a similar manner as current fuel injection systems. In addition to these features this invention will use some or all of the standard components in today's fuel injection systems. Moreover when the control module encounters a fuel's data that has a certain characteristic or characteristics the control module will calculate the amount of fuel that should be subtracted or added to the maps base fuel amount after the maps base amount of fuel has been modified, the fuel injection system will function the same as today's common fuel injection systems until some other fuel's characteristic has been down loaded. At which point the control module will recalculate the amount of fuel that is to be added to or subtracted from the map's base amount of fuel.

The above-identified methods and systems for the identification of fuel in an engine can be utilized alone or in conjunction with other fuel system controlling techniques. Moreover, each of the specific steps involved in the processes, described herein are easily modified or tailored to meet the peculiar design and operational requirements of the particular equipment that is in contact with the fuel and the anticipated operating environment in which the equipment is to be used.

### CROSS REFERENCE

Not applicable

### FEDERAL SPONSORSHIP

Not applicable

### BACKGROUND

The invention relates to the identification, handling, despising and ultimately the use of fuel and the data concerning a fuel's properties. The benefits of identifying the fuel's properties and transferring the data concerning the fuel's properties will be realized by the end user.

The end user will be a vehicles fuel injection system for an electronically controlled engine, and more particularly, to a system that will recalibrate the amount of fuel delivered to an engine after considering the properties of the fuel to be delivered. Using the method for the identification of and delivery of the fuel and the data concerning the fuel used in electronically controlled (fuel injected) internal combustion engines.

If the detected fuel is identified as having a certain set of characteristics or characteristic, for example high specific gravity due to alcohol additives, then the control module will make an addition to the amount of fuel to be injected for any given set of conditions applied to the fuel injection system. On the other hand if the detected fuel has a low specific gravity, low or no alcohol additives and no sulfur additives then the control module will make a subtraction in the amount of fuel that is to be injected for any given set of conditions applied to the fuel injection system. This invention's components/parts can be added to the existing fuel handling, dispensing and injection systems currently used today.

For example, current auto technologies employ a base map and this base map is modified after taking into consideration the conditions applied to various sensors. Current technologies use such sensors as air temperature, air mass, water temperature and so on. With this invention we will use all current technologies and add in the ability to evaluate the data concerning the fuel's properties.

Once the data concerning the fuel properties has been down loaded the fuel injection control module will make an addition or subtraction to the maps base fuel amount and more accurately inject the proper amount of fuel.

Common fuel injection systems use a control module which contains a base line map that will give a basic amount of fuel for any given set of parameters which commonly include RPM & throttle position etc. After the basic fuel amount has been determined the control module will Add to or subtract from this basic amount of fuel using the information supplied from a myriad of sensors which commonly include water temp, air temp, mass air, load applied to the engine and so on. The final fuel amount will be determined from the aforesaid. This is in open loop operation. After the engine gets warmed up to a predetermined temperature the control module will go in to closed loop function i.e. the O2 sensor will evaluate the amount of O2 in the exhaust stream. After all of the previous evaluations happen the O2 sensor will tell the control module that the fuel air mixture is rich or lean then the control module will effect an addition or subtraction of the amount of fuel to be injected into the engine this is an ongoing process. This is a very good way to achieve fuel economy good performance and low emission. However while the engine was in open loop operation it had no ability to evaluate the mistakes it was making with regards to the amount of fuel it was injecting. Due to this shortcoming the engine manufactures tend to run the engine slightly rich to guaranty that there will be no engine damage and or drivability problems do to lean fuel air ratios while in open loop. Also when in closed loop operation if the throttle is opened quickly the fuel injection has to revert back to the base fuel map in the seconds after the throttle is opened quickly the O2 readings are not considered and during this time the fuel delivery is on the rich side as well. To make things harder on the manufactures the fuel that is supplied for use in the engine can have different properties. The properties of the fuel have a large influence on how much fuel needs to be injected for proper operation. For example when the fuel at the pumps is oxygenated you will need to inject more of it for proper fuel air ratio this must be factored in to the base fuel map or the engine will run lean during the months that the fuel at the pumps is oxygenated. So it is clear that during the months that the fuel is not oxygenated that the base fuel map will be to rich during warm up and fast throttle opening as well as at other times. Clearly it would be better if the fuel injection system had and could evaluate the data concerning fuel and then compensate for the fuels properties before the fuel is injected.

Although the fuel that is readily available at the pumps is manufactured under tight guidelines there are still large variances in the fuel's properties. For example the fuels' vapor pressure, specific gravity and alcohol content as well as many other additives and properties have an effect on the engines drivability, economy, emissions and power output. The ASTM Designation: D4814-01a list 6 categories of drivability with respect to fuel vapor pressure alone, the ability to know the vapor pressure of the fuel being delivered to the engine would allow the control module to correct any drivability problems by choosing the appropriate amount of fuel for any giving vapor pressure. Specific gravity of the fuel has a great impact on the amount of fuel that needs to be delivered to the engine to achieve the proper air to fuel ratio. Since the weight of the fuel changes dramatically when alcohol and oxygenated blends are added. It will be advantageous to modify the fuel map's output/amount after considering the specific gravity or the weight of the fuel.

The invention would employ at least all or part of the appropriate test/evaluation processes as found in the ASTM Designation: D 4814-01a Standard Specification for Automotive Spark-ignition Engine Fuel, as well as all other fuel testing procedures currently used today.

The ability to deliver data concerning the fuel's properties to the control module and then have the control module compensate for a large variety of fuels will allow the fuel manufactures to supply a broader range of fuels that may have more of the alcohol or oxygenate blends which will give cleaner emissions without causing drivability problems.

### BRIEF SUMMARY OF THE INVENTION

This system and method is going to deliver to the end user the data concerning the fuels properties The end user is the vehicle engine's fuel injection system. This data will be used by the engine's modified fuel injected system The data will tell the fuel injection system what the properties of the fuel that is about to be injected in to the engine are. Using this information the modified control module will be able to add to or subtract from the map's base amount/output of fuel. This new amount of fuel will better suit the fuel that is about to be injected. Choosing a more accurate amount of fuel will give better fuel economy better power and lower emissions. The most notable improvements will be during the open loop operation of normal fuel injection systems operation but there will also be improvements in the closed loop operations. Prior to going to closed loop operation today's fuel injection systems rely on a map that was programmed for one type or quality of fuel. However the fuel that is at the pumps today has a large variance in the way it is manufactured. Some fuels are designed to pollute less during government-mandated months of the year. Currently the fuel available at the pumps today has three choices of octane to choose from. Different countries and or states have different regulations on fuel content.

If we can ascertain the properties of the fuel prior to injecting them we can improve fuel economy and drivability as well as decrease emissions. Additionally we will be able to use a broader range of fuels in our vehicles thereby allowing the fuel manufactures to use more anti pollutant fuel combinations as well as lower the cost of fuel production.

### BRIEF DESCRIPTION OF THE DRAWINGS

The above and other aspects, features, and advantages of the present invention will be more apparent from the following, more descriptive description thereof, presented in conjunction with the following drawings, wherein:

FIG. I is a flow chart showing the fundamentals of the fuel data transferring system.

### DETAILED DESCRIPTION OF THE INVENTION

The following description is of the best mode presently contemplated for carrying out the invention. This description is not to be taken in a limiting sense, but is made merely for the purpose of describing the general principals of the invention. The scope and breadth of the invention should be determined with reference to the claims.

The system/method (invention) well consists of a multi step process which is designed to deliver Fuel along with the data concerning the fuels properties through and via the normal every day delivery routes. The fuel along with the data concerning the fuel's properties will be delivered to the customers vehicle. This data will be received by the fuel injection control module. The control module will ascertain what the properties of the fuel are. Using this information the control module will make a computation to add to or subtract from the maps base amount of fuel. For instance if the control module encounters a fuel with 1 percent MTBE added it will make an addition to the amount of fuel to be injected. The amount to be added will be programmed into the control module and it will vary greatly on other factors for example engine size, RPM and so on. The control module will be programmed to recognize all the different fuel combinations available at the pumps today and beyond that it will be programmed to recognize and accommodate fuel combinations that are not at the pumps to day but that may be available in the future.

The above-identified methods and systems for the identification of fuel and delivery of same to an engine can be utilized alone or in conjunction with other fuel system delivery handling and controlling techniques. Moreover, each of the specific steps involved in the processes, described herein are easily modified or tailored to meet the peculiar design and operational requirements of the particular delivery, handling and fuel injection controls and the anticipated operating environment in which the aforesaid is to be used.

What is claimed is:

1. A system and method to, at some point during or after the fuel manufacturing process, evaluate the fuel's properties and characteristics and catalog the same in a format that will make the information (the data) easily transferable with the fuel to the end user. The end user is a fuel injection system in a motorized electronically fuel injected vehicle. The properties to be evaluated would include but not be limited to: specific gravity, octane, vapor pressure, sulfur content, oxidation stability, distillation properties, vapor-liquid ratio, phosphorus content, density, relative density, MTBE content, ETBE content, TAME content, DIPE content, tertiary-amly content, alcohol content, C1 to C4 alcohol content, gasoline-oxygenate blends, fuel temperature, and any other method or means to evaluate the properties of fuel, etc.

2. A device (the fuel data transfer system) that can be attached to or carried with a fuel container a fuel truck an in ground fuel tank or any means of transporting or storing fuel. This data transfer system is designed to accept data from another data transfer system. This will allow the information (the data) about the fuel to be delivered with the fuel to its next location. This fuel data transfer system is also designed to receive data concerning a secondary fuel's property and combine the properties of the new fuel with an amount of previously loaded fuel (the primary fuel) and the data concerning the primary fuel. This device will ascertain the new fuels data in relation to how much of the new fuel is loaded into the fuel container that the device is attached to at which point the new data and the new fuel will be added and combined with the old fuel and data consequently when this new fuel combination is dispensed to the next container or the end user its new combined data will go with it. The new data will be downloaded when the fuel is dispensed to the next container or to the end user. For example when the fuel truck dispenses fuel at/to a fuel station the fuel truck will down load the combined fuel's properties to the fuel station. This download can happen before during or after the fuel is pumped into the holding tank at the fuel Station. The fuel station will also have this device and a version of this device will be at every point in the delivery process that the fuel's Properties might change do to combining a fuel of a certain data (characteristic)with a fuel of some other data (characteristic) or for any other reason. This is done to guaranty that the data is known and preserved for delivery with the fuel to the end user.

3. A fuel injection system of a motorized vehicle that has a control module that is modified to accept data concerning a fuel's properties or characteristics. A fuel injection system of a motorized vehicle that has a control module that is modified to vary the amount of fuel that is injected after receiving and in relation to data that contains information about the fuel's properties or characteristics. When prompted by incoming information concerning the fuel's properties this control module will add to or subtract from the amount of time the control module would have normally opened the fuel injector in relation to and in consideration of the fuel's properties. And or in a “multi map system” the control module will switch to the appropriate map that matches the fuels properties. In layman's terms the amount of fuel that is to be injected by any means will be different than what would have normally been injected (changed) in relation to and in consideration of the fuel's properties. This system will work in conjunction with existing fuel injection technologies that are common to anyone skilled in the field of fuel injection.

4. A fuel injection control module that is programmed and modified to take into consideration the amount of fuel that is in the fuel tank and it's properties and characteristics (it's data) from a previous fuel stop and calculate and combine the same with the new amount of fuel and the properties of the new fuel that are now being pumped into and down loaded to the vehicle. The new value or data will then be used to recalculate or change the amount of fuel that will be injected in relation to the fuel's properties or characteristics. If the new data is different beyond a predetermined value then the control module will run a pump/the fuel pump to mix the fuel in the fuel system/tank to guaranty that the two fuels are mixed properly.

5. A method to identify a fuel's properties and or characteristics and catalog the properties and or characteristics into data, The properties to be evaluated would include but not be limited to: specific gravity, octane, vapor pressure, sulfur content, oxidation stability, distillation properties, vapor-liquid ratio, phosphorus content, density, relative density, MTBE content, ETBE content, TAME content, DIPE content, tertiary-amly content, alcohol content, C1 to C4 alcohol content, gasoline-oxygenate blends, any other method of identifying the properties of fuel, etc. The fuel and the data will be delivered together to the end user via normal delivery routes and using all normal means except that the data concerning the fuel will be carefully guarded and maintained and when two fuels are combined the data of the two potentially different fuels will be evaluated and combined and the new data and new fuel will then be passed onto the next location and or to the end user. The end user is the fuel injection system of the vehicle that the fuel and data will be pumped and downloaded into. The end user's fuel injection system will be modified to except the data and to use the data to recalculate/change the amount of fuel that is to be injected into the vehicle. After evaluating the data the fuel injection control module will add to or subtract from the amount of time that the control module would have opened the fuel injector under normal circumstances and or open the fuel injector further and or in a multi map system switch to a different map. In layman's terms add to or subtract from the amount of fuel to be injected by any means. This system will work in conjunction with existing fuel injection technologies that are common to anyone skilled in the field of fuel injection. This is all done so that the amount of fuel that would have been injected is changed to a more appropriate amount to compensate for the fuel's characteristics to achieve better fuel economy, better drive ability, more power, and lower emissions, while at the same time utilizing all of the benefits of today's common fuel injection systems.
